(19) United States
(12) Patent Application Publication
(10) Pub. No.: US 2015/0308576 A1
(43) Pub. Date: Oct. 29, 2015

(54) Integral Plastic Ball Valve for Fluid Transmission And Manufacturing Process

(71) Applicants: Doug Yelkin, Fayetteville, GA (US); Wei Hua Li, JiaXing City (CN)

(72) Inventors: Doug Yelkin, Fayetteville, GA (US); Wei Hua Li, JiaXing City (CN)

(21) Appl. No.: 14/262,726

(22) Filed: Apr. 26, 2014

(51) Int. Cl. F16K 5/06; B23P 15/00

(52) U.S. Cl. CPC F16K 5/0605; F16K 5/0657; B23P 15/001; F16K 5/0642

(57) ABSTRACT

The inventive concept relates to a completely integral ball valve manufactured by an injection fusing molding process. The device comprises a valve core, a valve housing, a valve control handle, and inlet/outlet flow pipes, all forming an integral structure. The valve core is the primary component of the ball valve, and is comprised of a spherical enclosure, a valve ball, left and right leakage seal rings, a spherical enclosure cap, a valve stem affixed to the valve ball, and a valve handle. The valve core, valve housing, and left and right intake/outflow pipes are integrally assembled by injection molding. The injection fusion molding process gives the ball valve higher flexion strength and greater durability as compared to the typical sweat soldering process. Precisely dimensioned mold sections ensure the accuracy of dimensions, fittings, and tolerances of the ball valve components during the injection fusing molding.

### CROSS-REFERENCES TO RELATED APPLICATIONS

Not applicable

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

(1) Field of the Invention

The inventive concept disclosed is involved with valve control mechanisms and systems used in controlling the transmission of fluids such as water, liquefied gas, petroleum, and other substances through pipelines. The inventive concept further includes manufacture utilizing an injection fusion molding process of a ball valve useful for such purposes.

(2) Description of the Related Art

Including information disclosed under 37 CFR 1.97 and 1.98. The following documents present devices and concepts that are in similar areas of endeavor as the disclosures in this application.

U.S. #2012/0227237. The invention discloses a structure for clamping a built-in component in a hollow container, the container being formed by clamp molding using a pair of a first mold piece and a second mold piece, the first mold piece being for forming a first half of the container, the second mold piece being for forming a second half of the container. The composition includes a first support member secured to an inner wall surface of the first half of the container and having a first connection portion and a first clamp portion; a second support member secured to an inner wall surface of the second half of the container having a second connection portion and a second clamp portion, wherein the built-in component is clamped between the first support member and the second support member with the first connection portion and the second connection portion coupled to each other.

U.S. #20110033657 The present invention discloses a metal shell manufacturing structure and method. The structure includes a metal substrate, at least one fixing groove, at least one plastic layer, and at least one assembling hole. The fixing groove is formed in the metal substrate and extends into the metal substrate from a surface of the metal substrate. The plastic layer is disposed on the metal substrate and fastened in the fixing groove. The assembling hole is formed in the plastic layer and extends into the plastic layer from a surface of the plastic layer. The formed plastic layer is fastened in the fixing groove directly and the plastic layer and the assembling hole can be formed in one piece via a mold, thereby simplifying the manufacturing process, reducing the costs and saving time. The present invention further discloses a metal shell manufacturing method.

Currently, there are a variety of plastic ball valves used for fuel gas transmission pipelines. A polyethylene ball valve disclosed in the Chinese Patent No. CN201836497U comprises a valve housing that is assembled by welding and has relatively poorer pressure resistant strength compared with an integrally molded structure. The ball valve is made in a complicated manufacturing process and installed by way of assembling. The assembly by welding is apt to cause its valve ports at both ends to be asymmetrical and not concentric with each other, resulting in high product rejection rate, low qualified product rate, low productivity, and high production costs. In a ball valve manufacturing process disclosed in the Chinese Patent No. CN101059177A, the disclosed valve comprises a valve housing formed by injection molding and an integral valve core in the structure; in other words, a valve stem and a valve ball are molded integrally by injection molding. However, the valve core is too simple in structure and has some defects.

### BRIEF SUMMARY OF THE INVENTION

The objective of the present invention is to improve, in a significant way, previous methods of manufacturing ball valves of the type utilized for transportation of various types of fluids through pipelines. The inventive concept disclosed overcomes deficiencies in ball valves existing in the prior art, by producing an integral plastic ball valve used for fluid transmission through varying sizes of pipelines, and a ball valve assembly which is durable, easy to manufacture and consistently reliable in the quality of its functions. The manufacturing process disclosed herein features a method of manufacturing a ball valve by means of injection fusion molding, thereby producing a final product that is free of mis-fitting parts, and that is manufactured with greater accuracy and closer tolerance dimensions.

The integral plastic ball valve disclosed herein comprises a valve core and a valve housing, wherein the valve housing is an integral structure, having the valve core securely fixed inside the valve housing. The valve core is the primary component of the ball valve, and is comprised of a spherical enclosure, a valve ball, left and right leakage seal rings, a spherical enclosure cap, and a valve stem which fits into the valve ball, and a valve handle. The valve core, valve housing, and left and right intake/outflow pipes are integrally assembled by injection molding. This manufacturing process thus gives the ball valve higher flexion strength and more lasting durability as compared to the typical sweat soldering process. The injection molding process is defined by a precisely dimensioned mold, thus the accuracy and tolerances of the ball valve are improved over the prior art methods which use individual technicians to properly fit together and assemble the various components of a ball valve.

The valve ball further comprises a through-hole which is designed to pivot by manipulation of an externally-connected valve handle acting through the valve stem and a corresponding polygonal socket on the top surface of the valve ball. Any possible leakage during fluid flow is prevented by the left and right leakage seal rings, the left leakage seal ring abutting the wall of the spherical enclosure and the right leakage seal ring abutting the second face of the spherical enclosure cap. A number of gasket O-rings are mounted in grooves around the exterior of the valve stem. A sealing gasket is also mounted between a first face of the spherical enclosure cap and the outer face of the spherical enclosure.

Nomenclature for Components of Inventive Concept

```
  1. Ball valve
  2. Valve core
  3. n/a
  4. Spherical enclosure
  4(a) Enclosure top
  4(b) Enclosure bottom
  5. Valve ball
  6. Left ball outlet
  7. Right ball outlet
  8. Ball polygonal socket
10. Left leakage seal ring
11. Right leakage seal ring
12. Lip
13. Aperture
14. Sealing gasket
15. Spherical enclosure cap
16. Circular flange
17. Cap first face
18. Cap opening
19. Cap second face
20. Valve stem
21. Valve handle
22. Handle cavity
23. Groove
24. Stem polygonal shaft
25. Gasket O-ring
26. Stem notch
27.-29. n/a
30.-31 n/a
32. Outer face
33. Left inner face
34. n/a
35. Barrel opening
36. Outer bottom
37. Left flow pipe
38. Right flow pipe
39.-49. n/a
50. Valve body housing (II)
51. Left main port
52. Right main port
53.-55. n/a
56. Left mold rod
57. Right mold rod
58. First mold cavity
59. Second mold cavity
```

### BRIEF DESCRIPTION OF THE VIEWS OF THE DRAWINGS

FIG. 1 presents the completely assembled ball valve 1 and its integral inlet and/or outlet pipes 37, 38.

FIG. 2 depicts a perspective view of the spherical enclosure 4, which forms the foundation for assembly of components to manufacture the ball valve 1 by fusion molding.

FIG. 3 presents a cross-sectional view of the spherical enclosure 4, as seen from the section line, 2-2; also shown is the left leakage seal ring 10 just prior to its placement against the inner face 33 of the spherical enclosure 4.

FIG. 4 shows a cross-sectional view of the left leakage seal ring 10 having been placed in abutment to the inner face 33 of the spherical enclosure 4.

FIG. 5 shows the valve stem 20 of the ball valve 1 along with circumferential grooves 23.

FIG. 6 illustrates the valve stem 20 having been fitted with three gasket O-rings 25 at critical points along the length of the valve stem 20.

FIG. 7 depicts the valve ball 5 just prior to its insertion into the spherical enclosure 4.

FIG. 8 illustrates the valve ball 5 inserted into the spherical enclosure 4 and in abutment with the left leakage seal ring 10.

FIG. 9 is a sectional view of the valve stem 20 in alignment with an aperture 13 atop the spherical enclosure 4 and the ball socket 8.

FIG. 10 is a sub-assembly comprising the spherical enclosure 4, valve ball 5, and the valve stem 20.

FIG. 11 illustrates the valve ball 5 and the ball polygonal socket 8 in the top surface of the valve ball 5.

FIG. 12 depicts a sectional view of the pending assembly of the spherical enclosure cap 15, a sealing gasket 14, and the right leakage seal ring 11.

FIG. 13 is a stand-alone view of the sealing gasket 14 shown in FIG. 12.

FIG. 14 is a sub-assembly consisting of the spherical enclosure cap 15, the sealing gasket 14, and the right leakage seal ring 11.

FIG. 15 presents the pending joining of the enclosure cap 15 sub-assembly with the spherical enclosure 4 containing the valve ball 5 and valve stem 20.

FIG. 16 depicts the assembled components of what is termed the valve core 2, as shown.

FIG. 17 shows the outlined pattern of the corresponding mold sections 58, 59 used in the final fusion molding process and further, the pending installation of the valve handle 21 onto the valve stem 20 and the valve body housing 50.

### DETAILED DESCRIPTION OF THE INVENTIVE CONCEPT

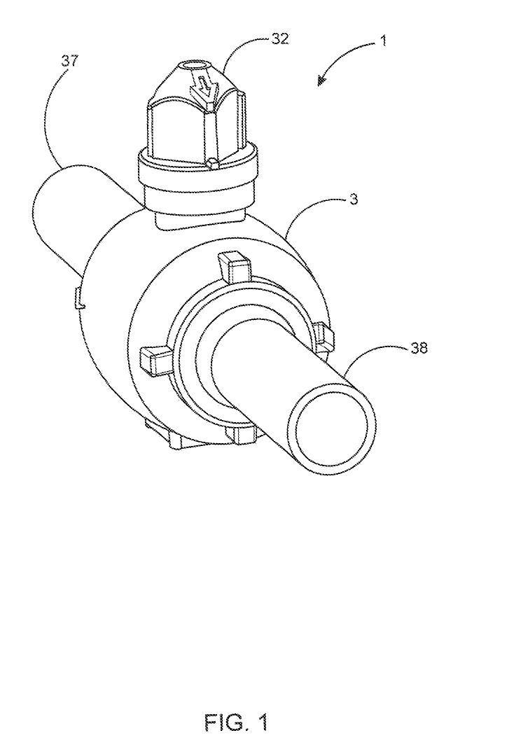

The inventive concept disclosed herein features a ball valve that is manufactured by a method comprising injection fusion molding. An understanding of the inventive concept is best conveyed by reference to the accompanying drawing figures, of which there are seventeen in number. A step-by-step tracking of the process of manufacturing the ball valve 1 provides a thorough explanation of the particular injection fusion molding process. Starting with FIG. 1, there is presented a completely assembled ball valve 1, with the outer valve housing 3, and integral inlet and/or outlet pipes 37, 38, the outlet pipes 37, 38 having been fabricated during the fusion process. Also shown is the ball valve 1 control handle 21 for setting the direction and volume of the flow of internally transmitted fluids and for shutting off the fluid flow.

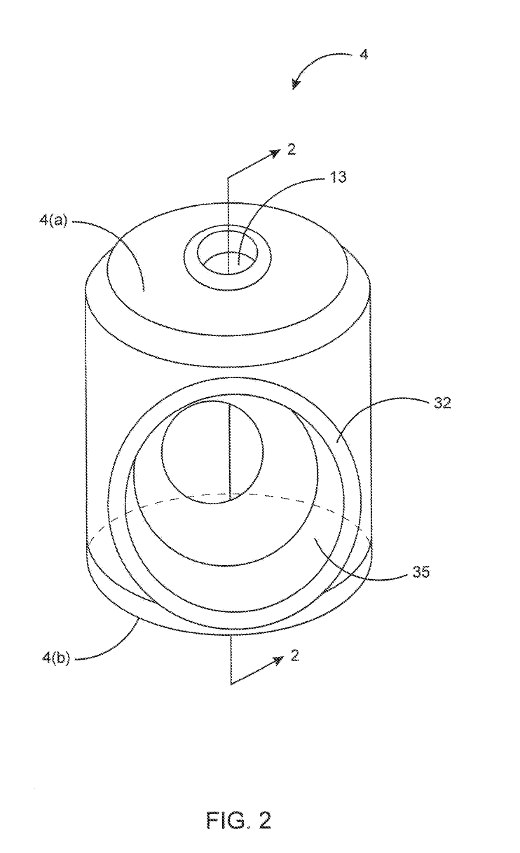

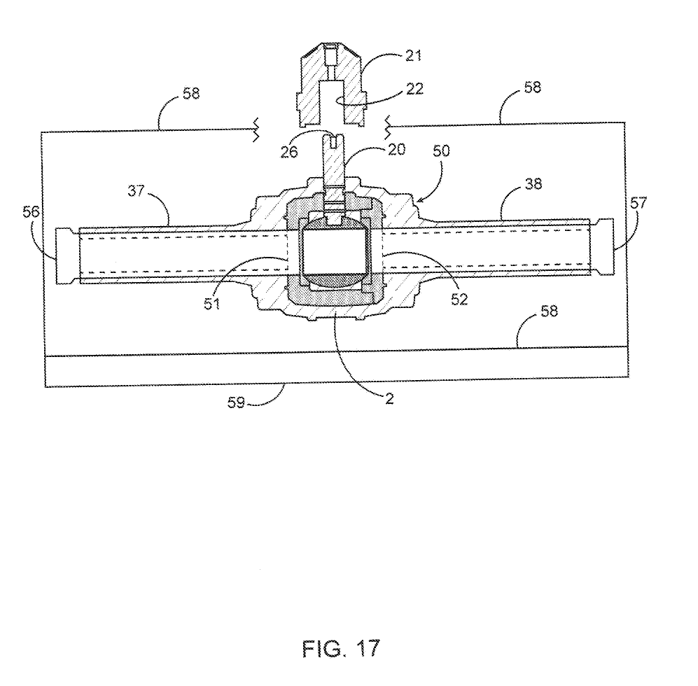

The primary component of the ball valve 1 assembly is the spherical enclosure 4, which is shown in perspective in FIG. 2. The spherical enclosure 4 is essentially a cylindrically-shaped unit having a top surface 4(a) having a centralized circular aperture 13, a bottom surface 4(b), a barrel opening 35, a ring-shaped vertically oriented outer face 32. The spherical enclosure 4 forms the foundation for assembly of the necessary components of the ball valve 1. Upon complete assembly of the components, what is termed a “valve core” 2 (shown in FIG. 16) is then placed into appropriate mold forms 58, 59 (shown in FIG. 17) to initiate the injection fusion molding process, as will be shown in the following discussions.

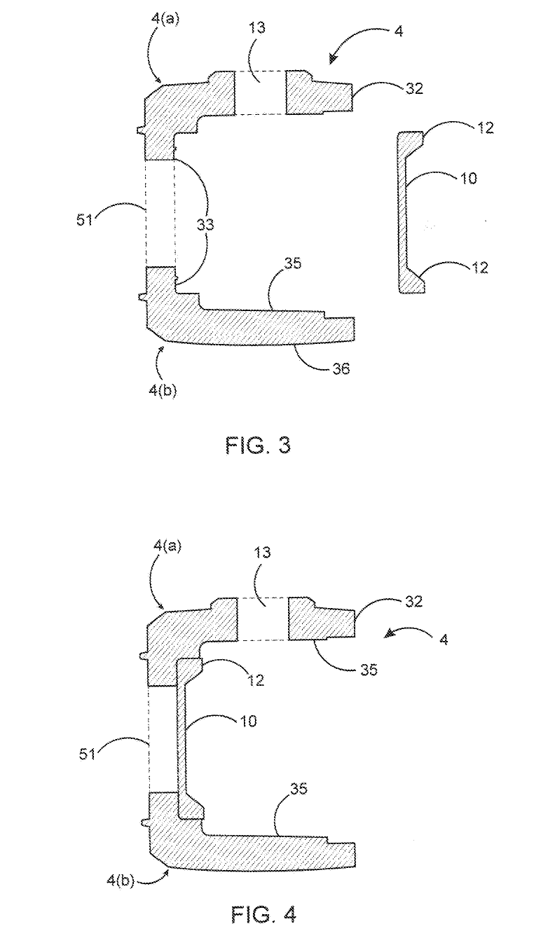

Referring to FIG. 3, there is presented a cross-sectional view of the spherical enclosure 4, as seen from section line, 2-2 of FIG. 2. To the right of the spherical enclosure 4 is shown a left leakage seal ring 10, which is essentially a gasket having a continuous circumferential lip 12 on the inner side of the left leakage seal ring 10. A right leakage seal ring 11 (not shown) is also made in an identical manner. In the pre-injection process, both leakage seal rings 10, 11 will be inserted in appropriate locations in the spherical enclosure 4. Further shown in FIG. 3 is a lip 12 which is contoured to fit snugly against the valve ball 5 upon complete assembly of the ball valve 1.

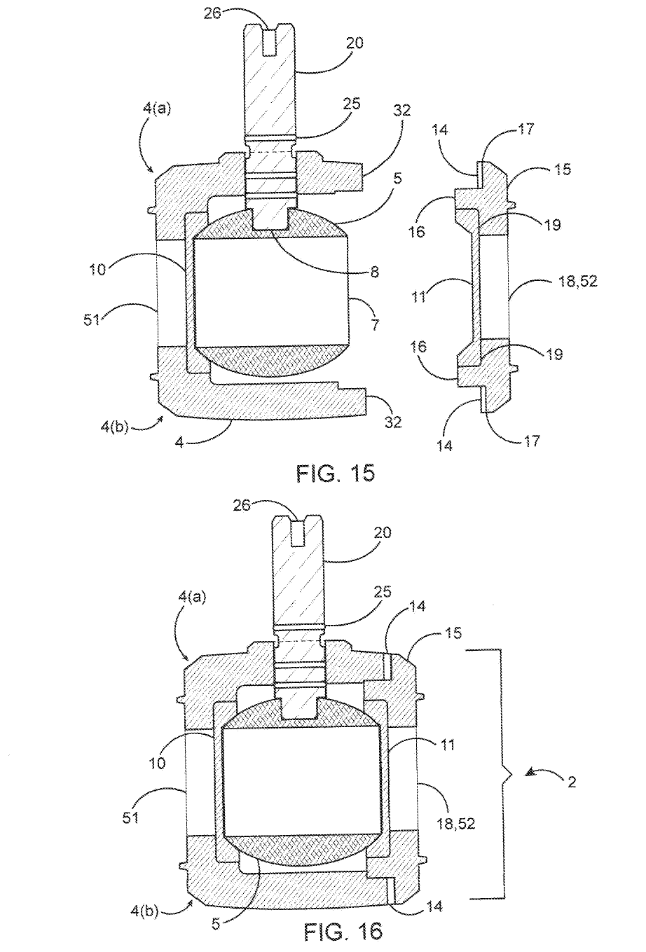

Also shown in FIG. 3 is the barrel opening 35 and the outer bottom 36 of the spherical enclosure 4. A flat, circular outer face 32 is constructed of dimensions which accommodate the snug fit of a gasket 14 and a spherical enclosure cap 15 (more clearly shown in FIG. 15 and FIG. 16). A circular inner face 33 is structured so as to accept an abutting fit of the surface of the left leakage seal ring 10 during assembly. A left main port 51 is depicted, which allows the fitting of a left flow pipe 37, which in turn facilitates the flow of a fluid into or out of the ball valve 1.

FIG. 4 shows the resulting sub-assembly after insertion of the left leakage seal ring 10 in direct abutment with the ring-shaped inner face 33 of the spherical enclosure 4.

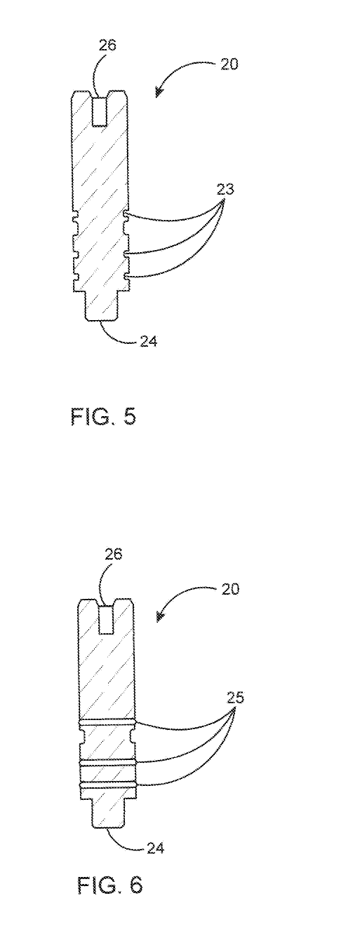

FIG. 5 illustrates a valve stem 20 which provides a mechanical union between the valve ball 5 (not shown) and a control valve handle 21 (also, not shown) which union thereby provides the means for manually controlling flow of a fluid through the fully assembled ball valve 1. The valve stem 20 further features three circumferentially-machined grooves 23 and a stem polygonal shaft 24, the shaft having a cross-section corresponding to the contours of a ball polygonal socket 8 (shown in FIG. 11). A stem notch 26 accommodates the attachment of a valve handle 21 as shown in FIG. 17.

FIG. 6 depicts the placement of an elastomeric gasket O-ring 25 into each of the three grooves 23 of the valve stem 20. The gasket O-rings 25 play a critical part in preventing the leakage of fluid around the exterior surface of the valve stem 20.

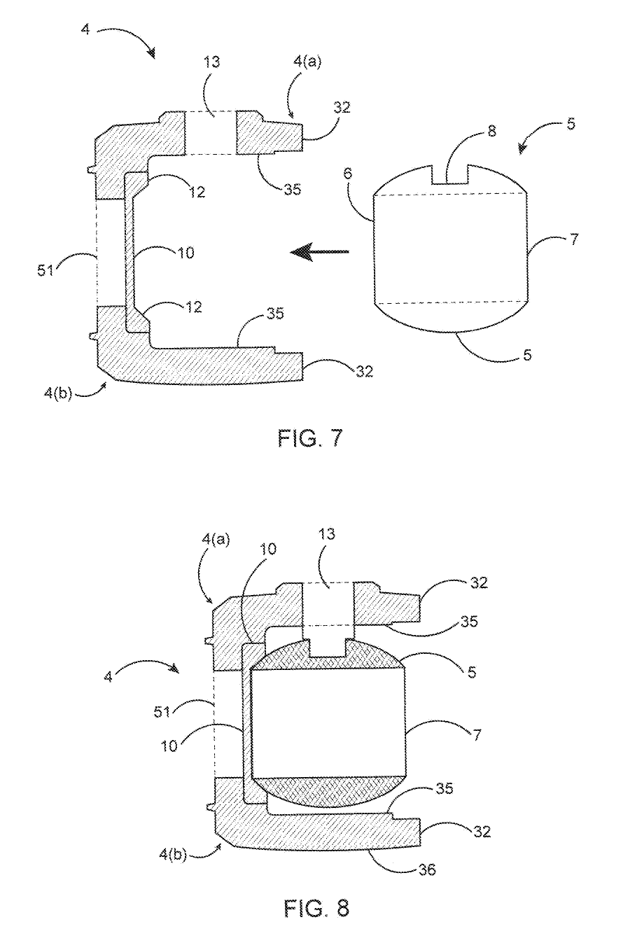

FIG. 7 shows another rendering of a cross-sectional view of the spherical enclosure 4 sub-assembly, as seen from section line 2-2. To the right of the spherical enclosure 4 in FIG. 7 is shown the valve ball 5 which is a spherical structure having a through-hole oriented left-to-right, the through-hole defining a left ball channel 6 and a right ball channel 7. On the top surface of the valve ball 5 is shown, by hidden lines, the polygonal-shaped socket 8 which is comprised of dimensions corresponding to the polygonal cross-section of the polygonal shaft 24 of the valve stem 20. At this point in time in the manufacturing process, the valve ball 5 is placed into the barrel opening 35 of the spherical enclosure 4, as is illustrated in FIG. 8, immediately following.

FIG. 8 demonstrates that the valve ball 5 is placed in abutment to the left leakage seal ring 10. It is also noted that the left ball channel 6 is co-axial with, and of a diameter corresponding to, the left main port 51 of the spherical enclosure 4. The contour of the left side of the valve ball 5 fits the contour of the circumferential lip 12 of the left leakage seal ring 10.

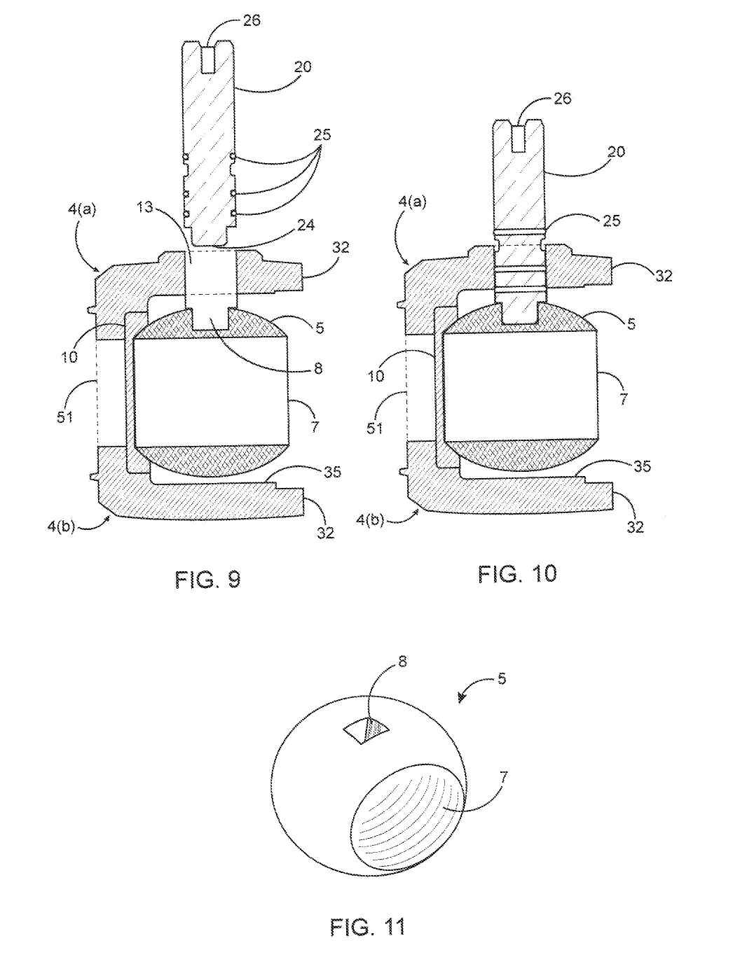

FIG. 9 presents the next sequential step in the manufacturing process, which depicts the pending insertion of the valve stem 20 into the sub-assembly comprising the spherical enclosure 4 and the valve ball 5. For further clarification, FIG. 11 is a perspective rendering of the valve ball 5, showing the right ball channel 7 and the ball polygonal socket 8. FIG. 10 illustrates the next stage of the sub-assembly process, comprising the spherical enclosure 4, the valve ball 5, and the valve stem 20. FIG. 10 also demonstrates the manner in which the valve shaft 24 fits snugly into the ball polygonal socket 8.

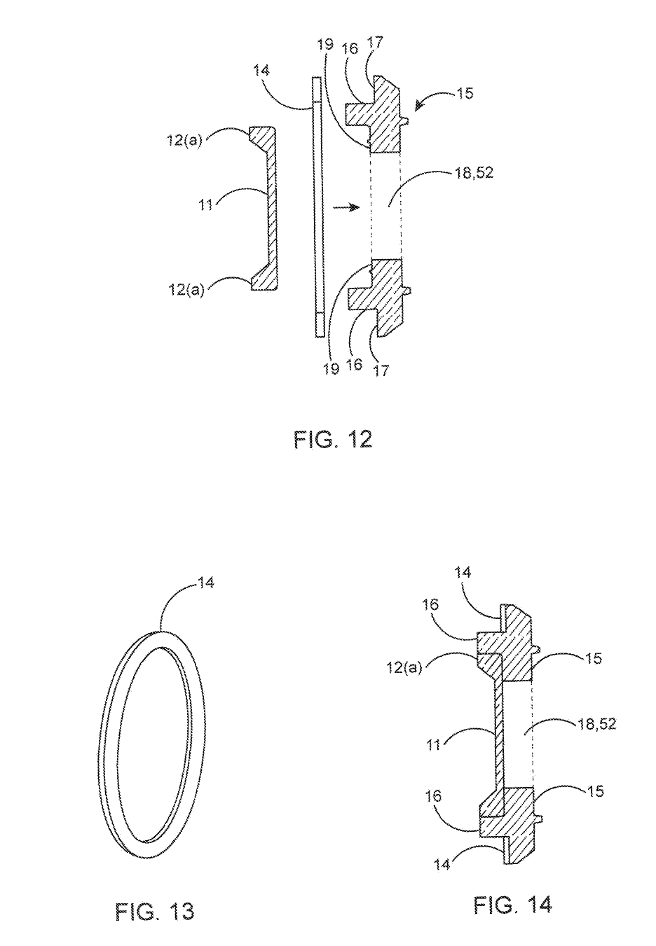

Proceeding with the assembly process, FIG. 12 shows individual components being, a cross-sectional view of a spherical enclosure cap 15, a sealing gasket 14, and further, a cross-sectional view of the right leakage seal ring 11. The spherical enclosure cap 15 comprises a cap first face 17, a cap circular opening 18, (which will ultimately form the right main port 52 of the ball valve 1), a cap second face 19, and a circular flange 16. FIG. 13 presents a perspective view of the sealing gasket 14, which will ultimately abut the outer face 32 of the spherical enclosure 4.

FIG. 12 demonstrates that the inner diameter of the sealing gasket 14 corresponds to the outer circumference of the flange 16, and that the flat face of the gasket 14 corresponds to the cap first face 17. The manufacturing process continues by placement of the sealing gasket 14 against the cap first face 17, to simultaneously fit about the outer circumference of the circular flange 16. The right leakage seal ring 11 is then placed so as to abut the cap second facer 19 and contemporaneously fit co-axially about the cap opening 18. The interior wall cap opening 18 corresponds in dimensions, to the right ball outlet 7 and also will ultimately form the right main port 52 of the ball valve 1. FIG. 14 then depicts the completed sub-assembly of the spherical enclosure cap 15 with the components shown in FIG. 12 and FIG. 13.

FIG. 15 displays the procedure for placing the completed sub-assembly of the spherical enclosure cap 15 so as to abut the outer face 32 of the spherical enclosure 4. FIG. 16 illustrates the final assembly of the essential valve core 2 of the ball valve 1. The valve core 2 assembly culminates in the through-hole of the valve ball 5 being co-axial with the left main port 51, the cap opening 18, and the right main port 52 of the valve core 2.

FIG. 17 represents the final phases of the injection molding process. In a separate operation in the sequence of the process, a left mold rod 56 having an outer circular diameter corresponding to the inner diameter of the left main port 51 is inserted, co-axially, into the left main port 51 of the valve core 2. A right mold rod 57 having an outer circular diameter corresponding to the inner diameter of the right main port 52 is inserted, co-axially, into the right main port 52 of the valve core 2. The valve core 2 and the conjoined valve stem 20 are then precisely placed into a custom-contoured first mold cavity 58. Also shown is the outline of a corresponding second mold cavity 59 having contours and dimensions exactly corresponding to the first mold cavity 58.

The first mold cavity 58 comprises dimensions so as to provide spacing for the formation of a left flow pipe 37 encircling the left mold rod 56 as the selected molten material is injected into the clamped mold cavities, 58, 59. Similarly, the first mold cavity 58 comprises dimensions so as to provide spacing for the formation of a right flow pipe 38 encircling the right mold rod 57. In this manner both flow pipes 37, 38 become integral to the ball valve 1 resulting from the injection of the selected molten material during the molding process.

The first mold cavity 58, as does the second mold cavity 59, further comprises contours to form a valve body housing 50. The valve body housing 50, in its final form, encloses the entire valve core 2. During the injection molding process, the body housing 50 thereupon becomes integral to the left and right flow pipes 37, 38. Simultaneously, the valve body housing 50 becomes integral to the valve core 2 and valve stem 20. Upon careful placement of the valve core 2 and the conjoined valve stem 20 into the first mold cavity 58, both mold cavities 58, 59 will be overlaid and clamped together in preparation for injection of a selected molten substance. After cooling and permanent setting of the molten material, the two mold cavities 58, 59, are separated and the left and right mold rods 56, 57 are removed. The valve core 2, complete with the left and right flow pipes 37, 38, is then removed from the first mold cavity 58 and the handle cavity 22 of the valve handle 21 is fitted onto the valve stem 20. The final ball valve assembly 1 is then trimmed and ready for service.

A major technical solution advanced by the present inventive concept is a process for manufacturing an integral plastic ball valve used for controlling the transmission of fluids through various sized pipelines. The term “plastic” is used in this disclosure to generally encompass a range of materials suitable for the components of the inventive concept, including, but not limited to polypropylene, polyethylene, and others. In preferred embodiments, the valve stem 20 is constructed of steel, polyformaldehyde, or aldehyde acetal; the spherical enclosure 4, valve ball 5, and spherical enclosure cap 15 are constructed of polypropylene. The valve housing 50, in the preferred embodiment, comprises polyethylene.

The preferred embodiments of the present invention, having been disclosed and described above in detail, it is understood that various changes and modifications can be made by one having skill in the art involved with this field of manufacture. Therefore, all technical solutions and/or variations arrived at by those skilled in the art, with respect to the concept of the present inventive concept, whether based on the prior art, logical analysis, or inferences, fall within the protective scope as defined by the claims herein.

What is claimed is:

1. An integral ball valve, comprised of plastic or similar material, utilized in controlling the transmission of fluids through various sizes of pipelines, comprising
(a) a spherical enclosure having a generally cylindrical structure and further having a top surface with a central circular aperture, a circular inner face, a bottom surface, an outer vertical face, a left leakage seal ring, and a barrel opening with a ring-shaped, vertical outer face;
(b) left and a right leakage seal rings, each seal ring having a first diameter and a raised lip extending continuously about the circumference of one side of each leakage seal ring;
(c) a rod-shaped valve stem having a plurality of circumferentially-circumscribed grooves into which are installed gasket O-rings, a top-most notch, and a bottommost shaft having a polygonal cross-section;
(d) a valve handle having an interior tubular-shaped cavity corresponding to the outer dimensions of said valve stem;
(e) a valve ball consisting of i) a sphere of outer diameter corresponding to the barrel opening of said spherical enclosure, ii) a through-hole of diameter corresponding to the first diameter of said leakage seal rings, said through-hole forming a left ball outlet and a right ball outlet, and iii) a topmost polygonal socket with a cross-section corresponding to the cross-sectional dimensions of the shaft of said valve stem;
(f) a spherical enclosure cap assembly consisting of a cap opening corresponding to the right ball outlet of said valve ball, a circumferential flange, a sealing gasket placed about the outer circumference of said flange, a right leakage seal ring, a cap first face, and a cap second face, said cap first face being placed in abutment to the outer vertical face of the spherical enclosure and thereby forming a valve core having a left main port and a right main port;
(g) a left flow pipe and a right flow pipe; and
(h) a valve body housing integral to, and encompassing the outer surfaces of said valve core, further encompassing said left main port and said right main port, simultaneously encompassing a segment of an end of the left flow pipe and an end of the right flow pipe, respectively; wherein
said valve ball occupies a fitted space within the barrel opening of said spherical enclosure, with placement of left and right leakage seal rings vertically on both sides of said valve ball and the through-hole lined up axially with the outer face of said spherical enclosure, the enclosure cap assembly is fitted onto the outer face of said spherical enclosure, the left and right flow pipes integral to, and projecting coaxially from the left and right sides of the valve body housing, the valve stem being securely attached to the valve ball polygonal socket such that the valve stem polygonal shaft is fitted into the polygonal socket of said valve ball, the valve body housing encompasses the valve core, the valve handle is fastened onto the uppermost part of the valve stem, and further, the left flow pipe and the right flow pipe extend coaxially and symmetrically from the left main port and the right main port of the valve body housing respectively.

2. An integral ball valve as in claim 1 wherein the valve stem is constructed of steel, the spherical enclosure, valve ball, and spherical enclosure cap are constructed of polypropylene, and the valve housing is constructed of polyethylene.

3. An integral ball valve as in claim 1, wherein the valve stem is constructed of polyformaldehyde, the spherical enclosure, valve ball, and spherical enclosure cap are constructed of polypropylene, and the valve housing is constructed of polyethylene.

4. An integral ball valve as in claim 1, wherein the valve stem is constructed of aldehyde acetal, the spherical enclosure, valve ball, and spherical enclosure cap are constructed of polypropylene, and the valve housing is constructed of polyethylene.

5. A process of injection fusion molding for the manufacture of an integral ball valve composed of plastic or similar substance, utilized in controlling the transmission of fluids through various sizes of pipelines, comprising the following steps:
(a) providing a spherical enclosure having a generally cylindrical structure and further having a a top surface with a central circular aperture, a circular wall, a bottom surface, a barrel opening, and a ring-shaped vertically oriented outer face;
(b) providing a left and a right leakage seal ring, each seal ring having a first diameter and a lip extending continuously about the circumference of one side of each leakage seal ring;
(c) placing the left leakage seal ring into the spherical enclosure so as to abut the inner face;
(d) providing a valve ball consisting of a sphere of outer diameter corresponding to the barrel opening of said spherical enclosure, a through-hole of diameter corresponding to the first diameter of said leakage seal rings, said through-hole forming a left ball outlet and a right ball outlet, and a topmost polygonal socket;
(e) placing said valve ball into the spherical enclosure such that the through-hole is co-axial with the circular wall, and such that the socket of said valve ball is oriented vertically upward proximate said central aperture;
(f) providing a rod-shaped valve stem having a plurality of circumferentially-circumscribed grooves into each groove which is fitted a gasket O-ring, a top-most notch, and a bottommost shaft having a polygonal cross-section corresponding to the cross-sectional dimensions of the socket of the valve ball;
(g) placing the valve stem downward through the central aperture such that the valve stem shaft is fitted into the valve ball socket;
(h) providing a spherical enclosure cap having a first inner face of a certain diameter, a second inner face of a smaller diameter than the first inner face, a cap opening corresponding to the right ball outlet of said valve ball, and a circumferential flange;
(i) fabricating a sub-assembly comprising a right leakage seal ring placed abutting the second face of said spherical enclosure cap and a sealing gasket placed snugly around the outer diameter of the flange of said spherical enclosure cap;
(j) placing the spherical enclosure cap sub-assembly flush against the outer face of said spherical enclosure such that the flange of the spherical enclosure cap fits snugly within the barrel opening of the spherical enclosure, thereby forming a valve core;
(k) co-axially placing a left mold rod and a right mold rod into the left ball outlet and the right ball outlet, respectively;
(l) providing an injection mold having a first section and a second section, each section comprising a concave profile corresponding to the general longitudinal shape of the valve core and the previously inserted left mold rod and right mold rod, thereby forming a housing encompassing said valve core, and further a left flow pipe and a right flow pipe;
(m) placing the valve core and mold rods into the first injection mold half, placing and securing the second mold half onto the first mold half, placing the combined mold in connection with an mold injection machine and initiating the flow of molten substance into the mold;
(n) allowing an adequate cooling time for the mold, and afterwards, removing an assembly comprising the integral valve housing and the left and right outlet/inlet pipes; and
(o) assembling the valve handle onto the valve stem of said valve core, thereby completing said ball valve.
